(19) United States
(12) Patent Application Publication
(10) Pub. No.: US 2024/0004017 A1
(43) Pub. Date: Jan. 4, 2024

(54) ANTENNA STRUCTURE

(71) Applicant: Qorvo US, Inc., Greensboro, NC (US)

(72) Inventors: Abdallah Dhouibi, Toulouse (FR); Matthias John, Newtownmountkennedy (IE)

(21) Appl. No.: 18/201,269

(22) Filed: May 24, 2023

Related U.S. Application Data
(60) Provisional application No. 63/381,415, filed on Oct. 28, 2022.
(60) Provisional application No. 63/357,280, filed on Jun. 30, 2022.

(51) Int. Cl. G01S 3/04; H01Q 9/04; H01Q 1/48; H01Q 21/06

(52) U.S. Cl. CPC G01S 3/043; H01Q 9/0414; H01Q 1/48; H01Q 9/0485; H01Q 21/065

(57) ABSTRACT

An antenna structure is disclosed that is well suited for use in dual- or multi-band wireless environments and sized so that it may be used in an antenna array for angle of arrival (AoA) detection. More specifically, an antenna may include a first antenna element, which may be an antenna element such as a patch antenna. The first antenna element is positioned in a first plane and positioned on first side of a substrate. On an opposite side of the substrate, a ground plane may be positioned in a second plane. The ground plane shapes the radiation pattern of the first antenna element to operate as a directional antenna. Sandwiched between the ground plane and the first antenna element is an intermediate antenna element constructed to act as a metamaterial that increases an effective distance between the ground plane and the first antenna element.

### PRIORITY CLAIMS

The present application claims priority to U.S. Provisional Patent Application Ser. No. 63/381,415 filed on Oct. 28, 2022, and entitled “ANTENNA STRUCTURE,” the contents of which are incorporated herein by reference in its entirety.

The present application also claims priority to U.S. Provisional Patent Application Ser. No. 63/357,280 filed on Jun. 30, 2022, and entitled “DUAL BAND ULTRA WIDEBAND ANGLE OF ARRIVAL ANTENNA ARRAY,” the contents of which are incorporated herein by reference in its entirety.

### BACKGROUND

### I. Field of the Disclosure

The technology of the disclosure relates generally to a low-profile antenna that is well suited for dual- or multi-band operation in an antenna array for detecting angle of arrival (AoA) in a millimeter wave domain, although other uses are also contemplated.

### II. Background

Computing devices abound in modern society, and more particularly, mobile communication devices have become increasingly common. While mobile communication devices may have begun as simple cellular phones and the like, end users and developers continue to find new functions which may be implemented or effectuated through such devices. Most such functions require wireless communication from the mobile device to a remote location. The evolution of wireless communication standards has caused numerous changes in the transceivers used within the mobile devices and created opportunities for innovation related to the antennas associated with the transceivers.

### SUMMARY

Aspects disclosed in the detailed description include an antenna structure. In particular, an antenna structure is disclosed that is well suited for use in dual- or multi-band wireless environments and sized so that it may be used in an antenna array for angle of arrival (AoA) detection. More specifically, an antenna may include a first antenna element, which may be an antenna element such as a wave launcher. The first antenna element is printed in a first plane and positioned on first side of a substrate. On an opposite side of the substrate, a ground plane may be positioned in a second plane. The ground plane shapes the radiation pattern of the first antenna element to operate as a directional antenna without increasing an overall size of the antenna. Sandwiched between the ground plane and the first antenna element is an intermediate antenna element constructed to act as a complementary metamaterial exhibiting a near-to-zero permittivity that increases the electric distance between the ground plane and the first antenna element without changing the overall size of the antenna for multiple frequencies of operation.

In this regard in one aspect, an antenna is disclosed. The antenna comprises a first multi-band antenna element positioned in a first plane. The antenna also comprises a ground plane spaced from the first multi-band antenna element such that the ground plane is positioned in a second plane parallel to the first plane. The antenna also comprises an intermediate antenna element positioned in a third plane between the first plane and the second plane and parallel to the first plane. The intermediate antenna element comprises a complementary metamaterial comprising a slot, wherein the complementary metamaterial is configured to space the ground plane from the first multi-band antenna element by an effective 214 distance.

In another aspect, an antenna is disclosed. The antenna comprises a first substrate having a first side and a second side. The first substrate has a first antenna element and a second antenna element positioned on the first side. The antenna also comprises a second substrate having a ground element associated therewith. The antenna also comprises a middle layer comprising a first metamaterial element associated with the first antenna element and a second metamaterial element associated with the second antenna element, wherein the middle layer is positioned adjacent to the second side.

### BRIEF DESCRIPTION OF THE DRAWINGS

FIG. 1A is a stylized representation of a location detection system that uses a wireless signal in an angle of arrival (AoA) antenna array to detect an approaching person;

FIG. 1B is a simplified illustration of an AoA antenna array detecting an object;

FIG. 2 is a cross-sectional elevation view of an antenna according to the present disclosure;

FIG. 3A-3D are top plan views of planes within the antenna of FIG. 2;

FIGS. 4A, 4C, and 4E illustrate various resonator structures, while FIGS. 4B, 4D, and 4F illustrate equivalent circuit diagrams that may be used in the antenna of FIG. 2; and

FIG. 5 is a block diagram of a mobile terminal, which may include the antenna of FIGS. 2-3D according to the present disclosure.

### DETAILED DESCRIPTION

The discussion below sets forth the necessary information to enable those skilled in the art to practice the present disclosure and illustrate the best mode of practicing the present disclosure. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description include an antenna structure. In particular, an antenna structure is disclosed that is well suited for use in dual- or multi-band wireless environments and sized so that it may be used in an antenna array for angle of arrival (AoA) detection. More specifically, an antenna may include a first antenna element, which may be an antenna element such as a patch antenna or wave launcher. The first antenna element is printed in a first plane and positioned on first side of a substrate. On an opposite side of the substrate, a ground plane may be positioned in a second plane. The ground plane shapes the radiation pattern of the first antenna element to operate as a directional antenna without increasing an overall size of the antenna. Sandwiched between the ground plane and the first antenna element is an intermediate antenna element constructed to act as a complementary metamaterial exhibiting a near-to-zero permittivity that increases an electric distance between the ground plane and the first antenna element without changing the overall size of the antenna for multiple frequencies of operation.

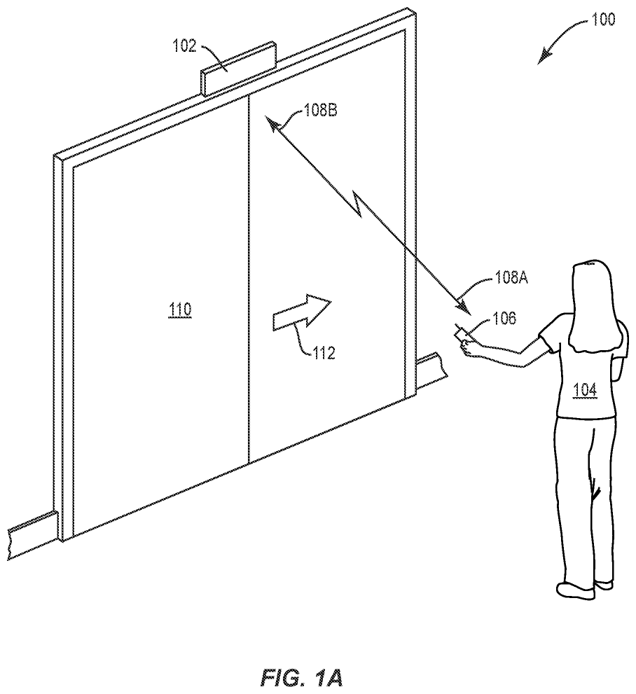

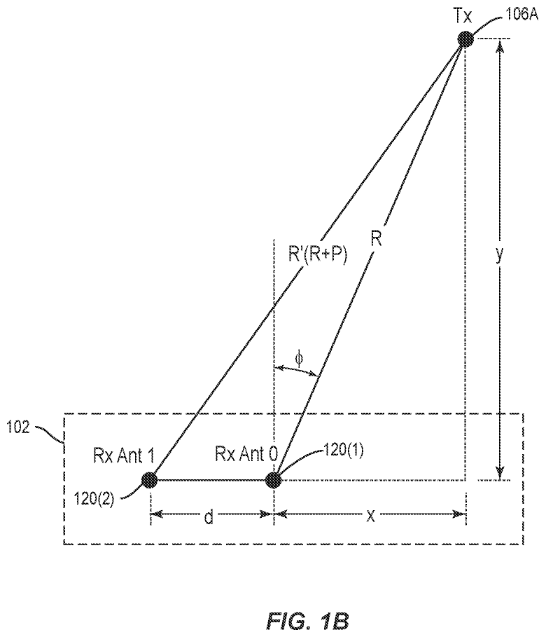

Before addressing exemplary aspects of the present disclosure, an overview of a conventional AoA system is disclosed along with a brief discussion of possible use cases with reference to FIGS. 1A and 1B. The shortcomings of such conventional systems in ultrawideband (UWB) environments are explained to help contrast with aspects of the present disclosure, a discussion of which begins below with reference to FIG. 2.

In this regard, FIG. 1A represents a general use case in an environment 100 where an antenna array 102 is used. In particular, a person 104 may be carrying a mobile terminal 106 that responds to an interrogation signal 108A with a responsive signal 108B when the mobile terminal 106 is within a predetermined distance of the antenna array 102. On receipt of the responsive signal 108B, a control system (not shown) may activate a motor or other drive mechanism (now shown) and open a door 110 (generally shown by motion arrow 112). Other possible use cases include swimmer detection when approaching a wall to assist in counting laps, inventory tracking in a warehouse, or the like.

The antenna array 102 may use AoA calculations to assist in determining a location of the mobile terminal 106 as better illustrated in FIG. 1B. An antenna 106A of the mobile terminal 106 (FIG. 1A) may emit electromagnetic radiation signals carrying information as is well understood. The antenna 106A may radiate the signals towards the antenna array 102. The antenna array 102 may include antennas 120(1), 120(2). The signal from the antenna 106A travels a distance R to the antenna 120(1) and a distance R′ (R+p) to the antenna 120(2). The distance R may be estimated from a time of flight measurement. Given that the distanced between the antennas 120(1) and 120(2) is known, it is possible to calculate the distance R′ from the phase difference in the signal as it arrives at the two antennas 120(1), 120(2). With the distances R and R′, it is possible to determine an x, y coordinate of the antenna 106A and thus determine the position of the mobile terminal 106 and/or the person 104. Thus, the antenna elements are effectively configured to provide signal measurements to assist in making AoA calculations.

For many frequencies and use cases, assembling a reasonably sized antenna array 102 with the antennas 120(1), 120(2) (or more) spaced an appropriate distance d apart (e.g., 212), is not difficult. However, at certain frequencies, and particularly in the UWB range (e.g., 3.1 gigahertz (GHz) to 10.6 GHz), it may be difficult to have an appropriately sized antenna adjacent to another antenna while still keeping the desired spacing.

Exemplary aspects of the present disclosure provide a relatively small footprint antenna that may be used in a UWB antenna array while still being small enough to provide desired λ/2 spacing. Further, exemplary aspects of the present disclosure allow for dual-band (or more (i.e., multi-band)) operation (e.g., UWB channels 5 and 9 (6.5 GHz and 8 GHz, respectively)) while still providing a radiation pattern that is relatively constant across the operating frequencies. While dual band is specifically contemplated, other multi-band structures could be used. Still further, aspects of the present disclosure contemplate a group delay for the frequency range that is relatively constant when the phase is linear through the frequency range. Such a condition will minimize distortion and/or dispersion of the signal so that measurements are more accurate.

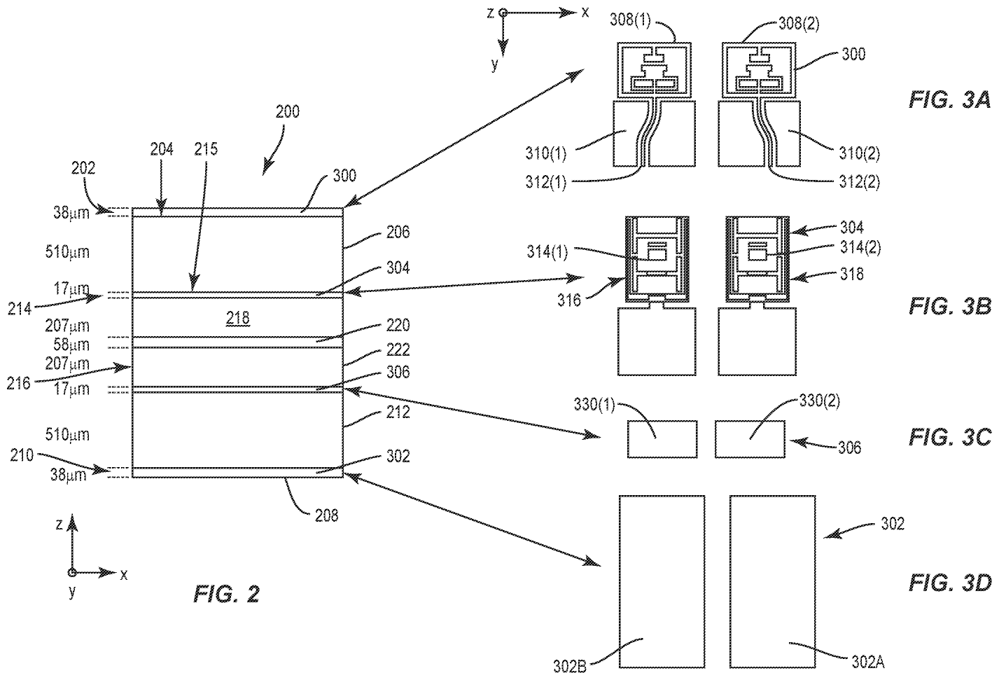

A side-elevational cross-sectional view of an exemplary antenna 200 according to the present disclosure is provided in FIG. 2. FIGS. 3A-3D provide top plan views of planes within the antenna 200. In particular, a first antenna element 300 (FIG. 3A) may be positioned in a first plane 202 on a first side 204 of a substrate 206. The substrate 206 may be a dielectric layer made from material such as FR4 and may, for example, be approximately 510 micrometers (μm) thick (z-axis). As used herein, approximately is defined to be within three percent (3%). The first antenna element 300 may be made from a copper material, although other conductive materials may be used. The material of the first antenna element 300 may have a thickness of, for example, approximately 38 μm. As better explained below with reference to FIG. 3A, the first antenna element 300 may be a multi-band antenna element such as a patch antenna or other wave launcher.

The antenna 200 may further have a ground plane 302 (see also FIG. 3D) positioned on a bottom surface 208 of the antenna 200. The ground plane 302 is spaced from the first antenna element 300 such that the ground plane 302 is positioned in a second plane 210 parallel to the first plane 202. The ground plane 302 may be made from a copper material, although other conductive materials may be used. The material of the ground plane 302 may have a thickness of, for example, approximately 38 μm. The bottom surface 208 may be formed by a second substrate 212. The second substrate 212 may be a dielectric layer made of a material such as FR4 and may, for example, be approximately 510 μm thick. The ground plane 302 may shape the radiation pattern of the first antenna element 300 to a directional antenna. However, to do so, the ground plane 302 must be spaced an effective distance from the first antenna element 300.

Exemplary aspects of the present disclosure contemplate using an intermediate antenna element 304 positioned in a third plane 214 between the first plane 202 and the second plane 210. The third plane 214 is parallel to the first plane 202 (and consequentially parallel to the second plane 210). The intermediate antenna element 304 is positioned adjacent to a second side 215 of the substrate 206. The second side 215 is opposite the first side 204. As explained in greater detail below with reference to FIG. 3B, the intermediate antenna element 304 is configured to space the ground plane 302 from the first antenna element 300 by changing the effective distance therebetween.

A third substrate 216 may be provided between the intermediate antenna element 304 and the second substrate 212. The third substrate 216 may be a laminate and have a first layer 218 of FR4 pre-impregnated 7628, a second layer 220 of FR4 pre-impregnated 106, and a third layer 222 of FR4 pre-impregnated 7628. In an exemplary aspect, the first layer 218 is approximately 207 μm thick, the second layer 220 is 58 μm thick, and the third layer 222 is approximately 207 μm thick. Other materials may be used.

Sandwiched between the second substrate 212 and the third substrate 216 may be a tuning intermediate element 306 (see also FIG. 3C). The tuning intermediate element 306 may thus be considered adjacent to the second substrate 212 and the third substrate 216. The tuning intermediate element 306 may be made from a copper or other conductive material and may be approximately 17 μm thick.

Turning now specifically to FIGS. 3A-3D, more details about the antenna elements are provided. In this regard, the first antenna element 300 shown in FIG. 3A may be a first patch antenna 308(1) and a second patch antenna 308(2). Patch antennas in general cover a hemisphere in “front” of an antenna substrate (e.g., printed circuit board (PCB)) and are well suited for use in wall or ceiling mounted applications. If monopole patch antennas are used, there may be ambiguity as to which side of the array a received pulse has originated. However, the presence of the ground plane 302 turns the patch antennas 308(1), 308(2) to directional antennas to avoid the possible ambiguity. The patch antennas 308(1), 308(2) are both positioned in the first plane 202. The patch antennas 308(1), 308(2) may be identical and may be shaped so as to provide dual-band (or more (i.e., multi-band)) functionality (e.g., UWB channels 5 and 9). The patch antennas 308(1), 308(2) may be associated with first ground elements 310(1), 310(2) which shield feed lines 312(1), 312(2). Signals may be provided to and pulled from the patch antennas 308(1), 308(2) by the feed lines 312(1), 312(2). The patch antennas 308(1), 308(2) are effectively configured to provide signal measurements for AoA calculations as outlined above.

The intermediate antenna element 304 shown in FIG. 2 is based on a subwavelength localized complementary metamaterial (i.e., using negative space within a conductive plane instead of wireline conductors) and can be polarized by an electric field being in the same plane as the third plane 214. Alternatively, the intermediate antenna element 304 may be polarized by a magnetic field being perpendicular to the third plane 214. Normally, such field configurations are difficult with simple planar microstrip lines. However, using the Babinet principle, a complementary structure may be used. That is, traditional copper traces are replaced with voids and voids are replaced with copper.

In this regard, the intermediate antenna element 304 may include identical metamaterial elements 314(1), 314(2), each containing a pair of I-shaped slots 316, 318 that act as LC (i.e., having an inductor and a capacitor) circuits having an effective length of λ/4.

The tuning intermediate element 306 shown in FIG. 3C may be two identically sized plates 330(1), 330(2) which are not complete ground planes, but do change the effective size of the ground plane 302.

The ground plane 302 shown in FIG. 3D may also be two identically sized ground elements 302A, 302B and cover substantially all of the x-y plane. It should be appreciated that vias (not shown) may interconnect the various planes.

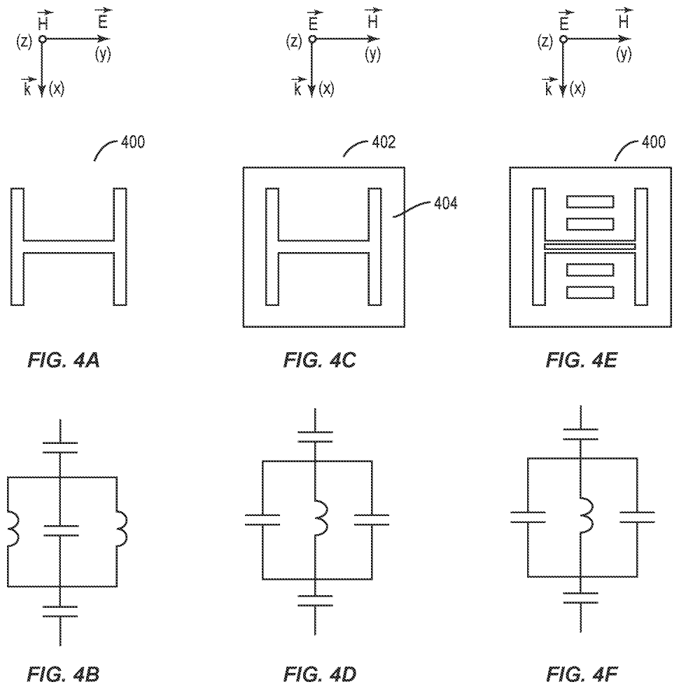

While an I-shaped slot such as slots 316, 318 of FIG. 3A is contemplated and discussed above, other shapes may also be used such as a Z-shape (not shown). Further, there may be variations on an I-shaped slot as better illustrated in FIGS. 4A, 4C, and 4E are possible. Equivalent circuit diagrams are provided in FIGS. 4B, 4D, and 4F respectively. Specifically, FIG. 4A and the equivalent circuit in FIG. 4B correspond to an I-shape 400. Note in this case, the I-shape is formed by actual conductors. In contrast, FIG. 4C shows an inverted I-shaped slot 402 which has the I-shape formed by the void in the conductive material 404. Again, FIG. 4D shows the equivalent circuit. FIG. 4E shows another variation of an inverted I additional cross bars 406(1)-406(5). The cross bars allow tuning of the LC elements in the equivalent circuit shown in FIG. 4F.

While particularly contemplated as being useful for an antenna array used to detect an AoA for a responsive device (e.g., a mobile terminal), the antenna structure according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a loudspeaker, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

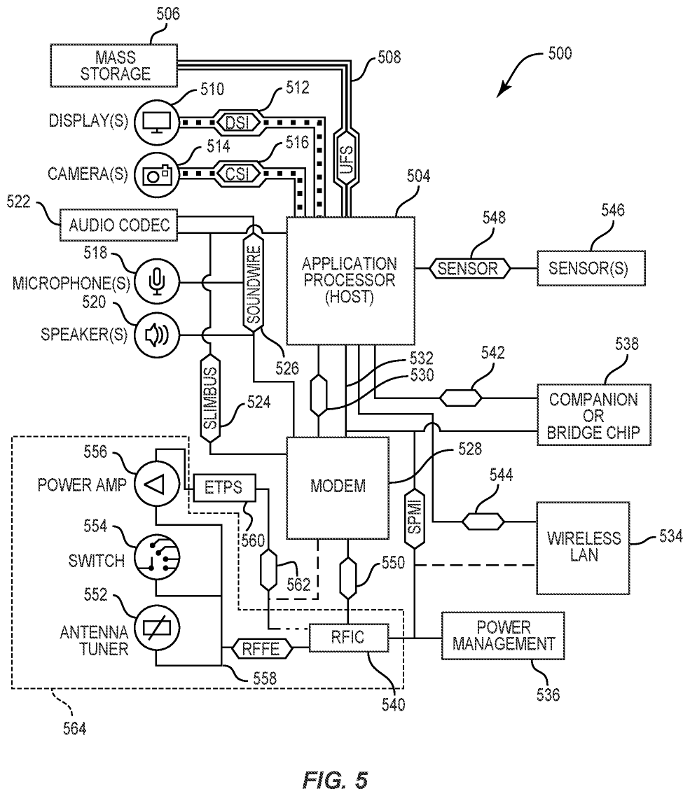

In this regard, FIG. 5 is a system-level block diagram of an exemplary mobile terminal 500 such as a smart phone, mobile computing device tablet, or the like. The mobile terminal 500 includes an application processor 504 (sometimes referred to as a host) that communicates with a mass storage element 506 through a universal flash storage (UFS) bus 508. The application processor 504 may further be connected to a display 510 through a display serial interface (DSI) bus 512 and a camera 514 through a camera serial interface (CSI) bus 516. Various audio elements such as a microphone 518, a speaker 520, and an audio codec 522 may be coupled to the application processor 504 through a serial low-power interchip multimedia bus (SLIMbus) 524. Additionally, the audio elements may communicate with each other through a SOUNDWIRE bus 526. A modem 528 may also be coupled to the SLIMbus 524 and/or the SOUNDWIRE bus 526. The modem 528 may further be connected to the application processor 504 through a peripheral component interconnect (PCI) or PCI express (PCIe) bus 530 and/or a system power management interface (SPMI) bus 532.

With continued reference to FIG. 5, the SPMI bus 532 may also be coupled to a local area network (LAN or WLAN) IC (LAN IC or WLAN IC) 534, a power management integrated circuit (PMIC) 536, a companion IC (sometimes referred to as a bridge chip) 538, and a radio frequency IC (RFIC) 540. It should be appreciated that separate PCI buses 542 and 544 may also couple the application processor 504 to the companion IC 538 and the WLAN IC 534. The application processor 504 may further be connected to sensors 546 through a sensor bus 548. The modem 528 and the RFIC 540 may communicate using a bus 550.

With continued reference to FIG. 5, the RFIC 540 may couple to one or more RFFE, elements, such as an antenna tuner 552, a switch 554, and a power amplifier 556 through a radio frequency front end (RFFE) bus 558. Additionally, the RFIC 540 may couple to an envelope tracking power supply (ETPS) 560 through a bus 562, and the ETPS 560 may communicate with the power amplifier 556. Collectively, the RFFE elements, including the RFIC 540, may be considered an RFFE system 564. It should be appreciated that the RFFE bus 558 may be formed from a clock line and a data line (not illustrated). The antenna structure of the present disclosure may be associated with the antenna tuner 552, the wireless LAN 534, or other transceiver, and the discussion of the structure of the mobile terminal 500 is provided by way of illustration, not a limitation.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. An antenna comprising:
a first multi-band antenna element positioned in a first plane;
a ground plane spaced from the first multi-band antenna element such that the ground plane is positioned in a second plane parallel to the first plane; and
an intermediate antenna element positioned in a third plane between the first plane and the second plane and parallel to the first plane, the intermediate antenna element comprising a complementary metamaterial comprising a slot, wherein the complementary metamaterial is configured to space the ground plane from the first multi-band antenna element by an effective 214 distance.

2. The antenna of claim 1, further comprising a first dielectric layer between the first plane and the third plane and a second dielectric layer between the second plane and the third plane.

3. The antenna of claim 1, further comprising a second multi-band antenna element positioned in the first plane.

4. The antenna of claim 3, further comprising a second intermediate antenna element positioned in the third plane.

5. The antenna of claim 1, wherein the first multi-band antenna element is a patch antenna.

6. The antenna of claim 1, wherein the slot comprises an I-shaped slot.

7. The antenna of claim 1, wherein the slot comprises an LC circuit having an effective length of λ/4.

8. The antenna of claim 1, wherein the intermediate antenna element comprises an LC circuit.

9. The antenna of claim 1, wherein the antenna is configured to be polarized by an electric field in the third plane.

10. The antenna of claim 1, wherein the antenna is configured to be polarized by a magnetic field perpendicular to the first plane.

11. An antenna comprising:
a first substrate having a first side and a second side, the first substrate having a first antenna element and a second antenna element positioned on the first side;
a second substrate having a ground element associated therewith; and
a middle layer comprising a first metamaterial element associated with the first antenna element and a second metamaterial element associated with the second antenna element, wherein the middle layer is positioned adjacent to the second side.

12. The antenna of claim 11, wherein the first antenna element is configured to operate at two frequencies.

13. The antenna of claim 11, wherein the first and second antenna elements are configured to provide signal measurements for angle of arrival calculations.

14. The antenna of claim 11, wherein the first antenna element comprises a copper material.

15. The antenna of claim 11, wherein the first substrate comprises an FR4 material.

16. The antenna of claim 11, wherein the first metamaterial element comprises an LC circuit.

17. The antenna of claim 11, wherein the first metamaterial element comprises an I-shaped slot.

18. The antenna of claim 11, wherein the first antenna element comprises a patch antenna configured to operate at ultrawideband frequencies.

19. The antenna of claim 17, wherein the first metamaterial element comprises a second I-shaped slot.

20. The antenna of claim 19, wherein the second metamaterial element comprises two I-shaped slots.
